(19) United States
(12) Patent Application Publication
(10) Pub. No.: US 2017/0120960 A1
(43) Pub. Date: May 4, 2017

(54) Removable Pickup Truck Tie Down Bar

(71) Applicant: William D. Whitmill, Goose Creek, SC (US)

(72) Inventor: William D. Whitmill, Goose Creek, SC (US)

(21) Appl. No.: 14/880,347

(22) Filed: Oct. 30, 2015

(51) Int. Cl. B62D 33/02; B62D 65/16

(52) U.S. Cl. CPC B62D 33/0207; B62D 65/16

(57) ABSTRACT

A removable pickup truck tie down bar for securing items in the bed of a pickup truck has installation brackets secured to the inner flange of the pickup truck, which permits the installation of a low-profile cover on the bed of the pickup truck, is less noticeable than a tie down bar located on the upper surface of the bed of a pickup truck, and is stronger than tie down bars located on the upper surface of the bed of a pickup truck. The bar portion may be removed by disengaging the installation pins. The bar portion may also have horizontal tie downs and vertical tie downs, used to secure cargo, and horizontal stops, used to prevent objects from moving forward when the pickup truck decelerates. The vertical tie downs, horizontal tie downs and lateral stops may be detachable to facilitate the installation of a low-profile bed cover.

### FIELD OF THE INVENTION

The present invention relates to tie-down bars used in the bed of pickup trucks to secure cargo. More particularly, the invention is a removable pickup truck tie-down bar utilizing installation brackets secured on the inner flange of the bed of a pickup truck and a bar portion removably connected to the installation brackets using pins.

### BACKGROUND OF THE INVENTION

Tie down bars are well known for securing cargo in the bed of a pickup truck. One drawback of the typical tie down bar is the fact that it is mounted to the upper surface of the bed of a pickup truck, which is weaker than the inner flange of the bed of the pickup truck and does not permit the installation of bed covers, including low-profile bed covers like the UnderCover LUX offered by UnderCover, Inc. of 59 Absolute Drive, Rogersville, Mo.

Slidably positioned tie down bars mounted to the inner flange of the bed of a pickup truck currently exist. For instance, a cargo management system for use in the bed of a pickup truck is available from JAC Products, Inc. of Saline, Mich., as described in U.S. Pat. No. 7,878,743 B2.

These slidably positioned tie down bars may be positioned in different places along the length of the bed of the pickup truck. Therefore, when the tie down bar is moved, the user cannot be assured that the tie down bar is mounted in the exact same place every time. Moreover, the tie down bar for this slidably positioned system cannot be removed by disengaging two pins. Further, these slidably positioned tie down bars do not contain vertical tie downs, horizontal tie downs, or lateral stops.

A tie down bar is needed that mounts to the inner flange of a pickup truck and thereby permits the installation of low profile bed covers, that may be easily removed and replaced in a way that assures the user that the bar is always placed in same spot in the pickup truck, and that can be configured to provide means to safely secure cargo by using a securing attachment device, such as a rope, by providing one or more horizontal tie downs and vertical tie downs. In addition, a tie down bar is needed that allows long, flat cargo, such as a ladder, to rest horizontally on the tie down bar and the tailgate upper surface and provides lateral stops to prevent the long, flat cargo from striking the rear window of a pickup truck when it decelerates. In some installations, if a low-profile bed cover is used on the pickup truck, the lateral stops and vertical tie downs must be detached so that they do not prohibit closure of the low-profile bed cover. In addition, if the vertical tie downs, horizontal tie downs and lateral stops are detachable, the user may add or remove them as needed.

### BRIEF SUMMARY OF THE INVENTION

The present invention provides a tie down bar for securing cargo in the bed of a pickup truck utilizing installation brackets secured on the inner flange of the bed of a pickup truck and a bar portion removably connected to the installation brackets using pins. This results in a tie down bar that is strong, that permits the installation of bed covers, including low-profile bed covers, and that may be removed and replaced by operating installation pins. The component parts of the tie down bar are simple and economical to manufacture, assemble and use. Other advantages of the invention will be apparent from the following description and the attached drawings or can be learned through practice of the invention.

For example, in one embodiment according the present disclosure, a removable pickup truck tie down bar is provided, which may include a bar portion having a first end and a second end. The first end of the bar portion may have a first pin hole. The second end of the bar portion may have a second pin hole and be disposed on the bar portion opposite the first end.

The removable pickup truck tie down bar may also include a first installation bracket. The first installation bracket may have a first mounting flange and a first retaining flange. The first mounting flange of the first installation bracket may define therethrough a pair of collinear first pin apertures. The first mounting flange of the first installation bracket may be attachable to a driver's side inner flange of the bed of a pickup truck by, for instance, using bolts screws, self-tapping screws, rivets or similar means of attachment. Retainers, such as nuts, may be placed on the bolts or screws opposite the driver's side inner flange from the first installation bracket.

The removable pickup truck tie down bar may also include a second installation bracket. The second installation bracket may have a second mounting flange and a second retaining flange. The second mounting flange of the second installation bracket may define therethrough a pair of collinear second pin apertures. The second mounting flange of the first installation bracket may be attachable to a passenger's side inner flange of the bed of a pickup truck by, for instance, using bolts, screws, self-tapping screws, rivets or similar means of attachment. Retainers, such as nuts, may be placed on bolts or screws opposing the passenger's side inner flange from the second installation bracket.

The removable pickup truck tie down bar may also include a first end pin positioned through the first pin hole of the bar portion and through the pair of collinear first pin apertures of the first installation bracket to connect the first end of the bar portion to the first installation bracket. The first end pin may be removed from the first pin hole of the bar portion and the pair of first pin apertures of the first installation bracket to disconnect the bar portion from the first installation bracket.

The removable pickup truck tie down bar may also include a second end pin positioned through the second pin hole of the bar portion and the pair of collinear second pin apertures of the second installation bracket to connect the second end of the bar portion to the second installation bracket. The second end pin may be removed from the second pin hole of the bar portion and the pair of second pin apertures of the second installation bracket to disconnect the bar portion from the second installation bracket.

The rod portion of the exemplary removable pickup truck tie down bar may also have one or more horizontal tie downs that may be used to limit horizontal movement of cargo within the pickup truck by securing the cargo to the horizontal tie down using a securing attachment device. These horizontal tie downs may be detachable from the rod portion.

The rod portion of the exemplary removable pickup truck tie down bar may also have one or more vertical tie downs that may be used to limit the vertical movement of cargo within the pickup truck by tying the cargo to the horizontal tie down. These vertical tie downs may be detachable from the rod portion.

The rod portion of the exemplary removable pickup truck tie down bar may also have one or more lateral stops that may be used to limit the horizontal movement of cargo residing above the above the rod portion. These lateral stops may be detachable from the rod portion.

The rod portion of the exemplary removable pickup truck tie down bar may also have a flat upper surface and may have a generally rectangular cross section.

The first installation bracket of the exemplary removable pickup truck tie down bar may also have a first horizontal member located on the first retaining flange of the first installation bracket. Similarly, the second installation bracket of the exemplary removable pickup truck tie down bar may also have a second horizontal member located on the second retaining flange of the second installation bracket. When this configuration is installed, the bar portion may be disconnected from the first installation bracket and the second installation bracket, which will cause the first end of bar portion to rest on the first horizontal member of the first installation bracket and the second end of the bar portion to resst on the second horizontal member of the second installation bracket. Further, the first horizontal member strengthens the first retaining flange of the first installation bracket, and the second horizontal member strengthens the second retaining flange of the second installation bracket.

The first installation bracket of the exemplary removable pickup truck tie down bar may also have mounting holes disposed on the first installation flange. The second installation bracket of the exemplary removable pickup truck tie down bar may also have mounting holes disposed on the second installation flange.

The disclosures also provides methods of installing the removable pickup truck tie down bar in the bed of a pickup truck. For instance, the method may include providing a bar portion having a first end and a second end, the first end having a first pin hole and the second end having second pin hole and disposed opposite the first end; providing a first installation bracket having a first mounting flange and a first retaining flange, the first retaining flange defining therethrough a pair of collinear first pin apertures; securing the first mounting flange of the first installation bracket to a driver's side inner flange using securing means; providing a second installation bracket having a second mounting flange and a second retaining flange, the second retaining flange defining therethough a pair of collinear second pin apertures; securing the second mounting flange of the first installation bracket to a passenger's side inner flange opposite the first mounting flange using securing means; aligning the first pin hole of the bar portion with the pair of collinear first pin apertures from the first installation bracket; positioning a first-end pin through the first pin hole of the bar portion and the pair of collinear first pin apertures to connect the first end of the bar portion to the first installation bracket; aligning the second pin hole of the bar potion with the pair of collinear second pin apertures from the second installation bracket; and positioning a second-end pin through the second pin hole of the bar portion and the pair of collinear second pin apertures of the second installation bracket to connect the bar portion to the second installation bracket.

The method may also include providing a rod portion that has one or more horizontal tie downs, one or more vertical tie downs, one or more lateral stops, or any combination of the foregoing.

The method may also include providing a rod portion that has a flat upper surface that may reside in a plane that is parallel to the plane of a tailgate upper surface when the first installation bracket and second installation bracket are mounted so that a line through the center of the pair of first collinear pin apertures is coplanar with a line through the center of the pair of collinear second pin apertures and parallel to a plane created by the tailgate upper surface. The flat upper surface of the rod portion may be coplanar with the plane of a tailgate upper surface by mounting the first installation bracket and the second installation bracket so that a line through the center of the pair of first collinear pin apertures is coplanar with a line through the center of the pair of collinear second pin apertures, parallel to a plane created by the tailgate upper surface, and is located an equal distance below the flat upper surface of the rod portion and the tailgate upper surface.

The method may also include providing a first installation bracket that has a first horizontal member located on the first retaining flange and providing a second installation bracket that has a second horizontal member located on the second retaining flange; and, before the first pin hole of the bar portion is aligned with the pair of collinear first pin apertures from the first installation bracket and before the second pin hole of the bar potion is aligned with the pair of collinear second pin apertures from the second installation bracket, placing the first end of the bar portion on the first horizontal member and the second end of the bar portion on the second horizontal member.

In another embodiment according to the present disclosure, a removable pickup truck tie down bar may include a bar portion of a generally rectangular cross section having a horizontal tie down, a vertical tie down, a horizontal stop, a first end and a second end disposed opposite the first end; a first pin hole located near the first end of the bar portion; a second pin hole located near the second end; a first installation bracket having a first mounting flange and a first retaining flange, the first mounting flange attachable to a driver's side inner flange, the first retaining flange having a first horizontal member and a pair of collinear first pin apertures; a second installation bracket having a second mounting flange and a second retaining flange, the second mounting flange attachable to a passenger's side inner flange, the second retaining flange having a second horizontal member and a pair of collinear second pin apertures; a first-end pin positioned through the first pin hole of the bar portion and through the pair of collinear first pin apertures to connect the first end of the bar portion to the first installation bracket, the first-end pin being removable from the first pin hole and the pair of collinear first pin apertures to disconnect the bar portion from the first installation bracket; and a second-end pin positioned through the second pin hole and through the pair of collinear second pin apertures to connect the bar portion to the first installation bracket, the second-end pin being removable from the second pin hole and the pair of collinear second pin apertures to disconnect the bar portion from the first installation bracket.

Other aspects and advantages of the invention will be apparent from the following description and the attached drawings, or can be learned through practice of the invention.

### BRIEF DESCRIPTION OF THE DRAWINGS

The above and other aspects and advantages of the present invention are apparent from the detailed description below and in combination with the drawings in which:

FIG. 1 is a perspective view of a removable pickup truck tie down bar according to an aspect of the disclosure installed in the bed of pickup truck;

FIG. 2 is a partial perspective view of the removable pickup truck tie down bar shown in FIG. 1;

FIG. 3 is an exploded partial perspective view of the removable pickup truck tie down bar shown in FIG. 1 (Driver's side);

FIG. 4 is an exploded partial perspective view of the removable pickup truck tie down bar shown in FIG. 1 (Passenger's side);

FIG. 5 is a view of a first installation bracket and a second installation bracket of a removable pickup truck tie down bar according to an alternative aspect of the disclosure;

FIG. 6 is a perspective view of the removable pickup truck tie down bar shown in FIG. 1, particularly showing cargo, specifically a ladder, secured to the removable pickup truck tie down bar; and

FIG. 7 is another perspective view of the removable pickup truck tie down bar shown in FIG. 1, particularly showing another arrangement of cargo, specifically a box and a drum, secured to the removable pickup truck tie down bar.

### DETAILED DESCRIPTION OF THE DRAWINGS

Detailed reference will now be made to the drawings in which examples embodying the present invention are shown. The detailed description uses numerical and letter designations to refer to features in the drawings. Like or similar designations in the drawings and description have been used to refer to like or similar parts of the invention.

The drawings and detailed description provide a full and detailed written description of the invention, and of the manner and processes of making and using it, so as to enable one skilled in the pertinent art to make and use it, as well as the best mode for carrying out the invention. However, the examples set forth in the drawings and detailed description are provided by way of explanation of the invention and are not meant as limitations of the invention. The present invention thus includes any modifications and variations of the following examples as come within the scope of the appended claims and their equivalents.

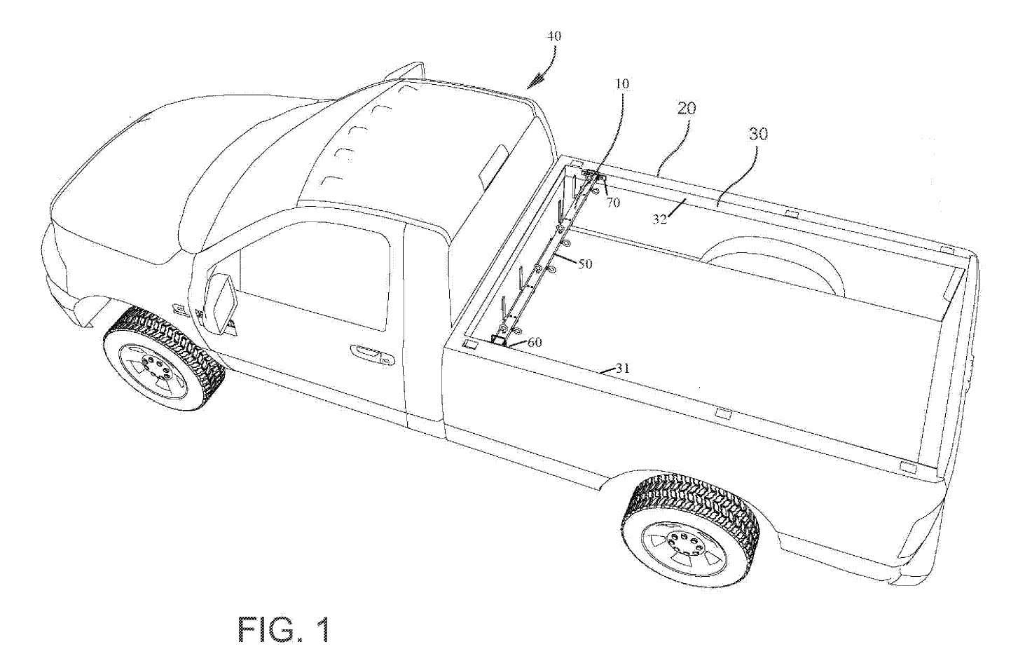

Turning now to FIG. 1, a removable pickup truck tie down bar is designated in general by the element number 10 and is shown installed in the bed 20 of a pickup truck 40. More particularly, the removable pickup truck tie down bar 10 is mounted to the inner flange 30 of the bed 20 of a pickup truck 40. The removable pickup truck tie down bar 10 consists of a bar 50, a first installation bracket 60 and a second installation bracket 70. The first installation bracket 60 is attached to the driver's side inner flange 31, and the second installation bracket is attached to the passenger's side inner flange 32. As described in detail below, the components of the removable pickup truck tie down bar 10, their placement and dimensions are modifiable to accommodate various pickup truck sizes, preferences and load requirements and are not limited to only those examples shown in the Figures. For instance, although the removable pickup truck tie down bar 10 is depicted as having generally a rectangular cross section, any cross section, such as square, circular, triangular or combinations of these and other shapes are within the scope of the present invention. Additionally, the bar 50 can be sized to meet customer requirements, such as by adjusting the length of the bar 50 (from about 60 inches to about 100 inches) to accommodate the width of different pickup trucks or by adjusting the size of the cross section and material thickness of the bar 50 to accommodate increasing loads.

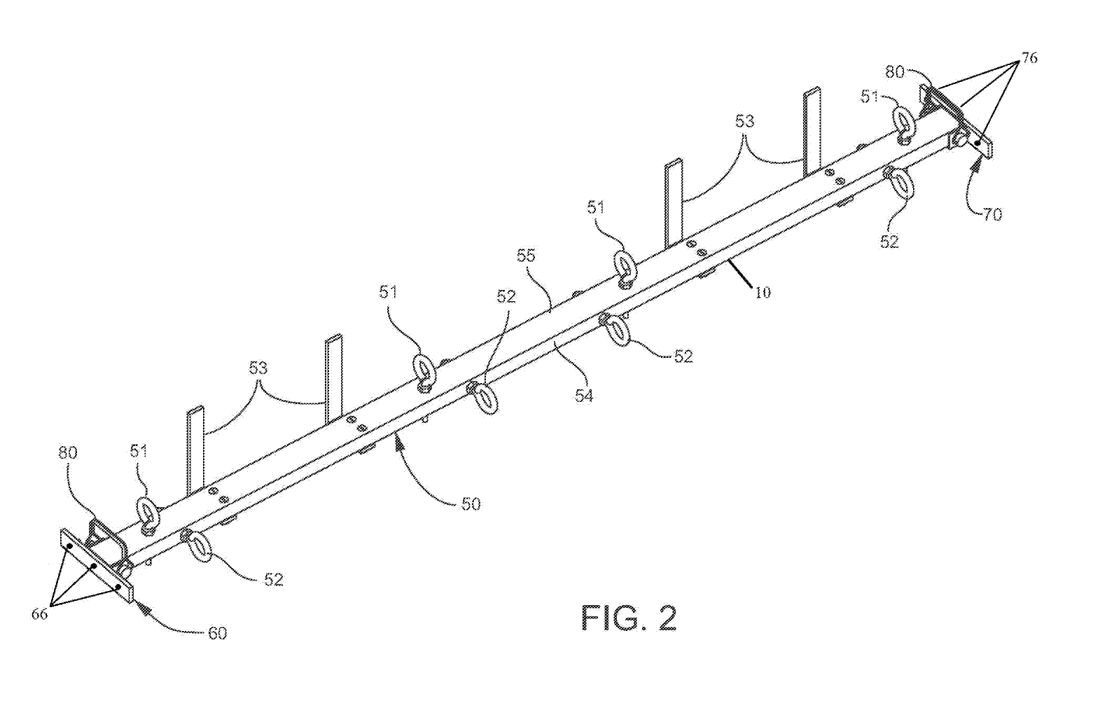

Turning now to FIG. 2, the removable pickup truck tie down bar 10 generally includes a bar 50, a first installation bracket 60, a second installation bracket 70, and two pins 80 The pins 80 are used to connect the first installation bracket 60 to the bar 50 and the second installation bracket 70 to the bar 50. The first installation bracket 60 may contain mounting holes 63, and the second installation bracket 70 may also contain mounting holes 73. The bar 50 may include one or more vertical tie downs 51, one or more horizontal tie downs 52, and one or more lateral stops 53. In one aspect of the invention, the bar 50 has four vertical tie downs 51, four horizontal tie downs 52 and four lateral stops 53. The bar may also define a cargo surface 54 and an upper surface 55.

The bar 50 may be made of aluminum, wood, steel, synthetic materials or any similar substances or combinations thereof. In one aspect of the invention, the bar 50 is made of 1 inch by 2 inch rectangular 6061-T6 aluminum tubing having a wall thickness of 0.125 inches, although other sizes and wall thicknesses can be made to meet specific requirements.

Similarly, the first installation bracket 60 and second installation bracket 70 may be made of aluminum, steel, synthetic materials or any similar substances of combinations thereof. In one aspect of the invention, the first installation bracket 60 and the second installation bracket 70 may be a weldment of ¼ inch thick aluminum plate.

The horizontal tie downs 51 and vertical tie downs 52 may be threaded eye bolts that may be secured to the bar 50 with retainers, such as nuts with nylon locking elements, or may be screwed directly into the bar 50 if it is threaded, both of which will allow the horizontal tie downs 51 and vertical tie downs to be detached from the bar 50. In addition, the horizontal tie downs and vertical tie downs can be made from many other types of devices, including studs, D-shaped rings, J-Bolts, threaded hooks or combinations of these and other devices. These devices may be welded to the bar 50 or may incorporate other means of attachment to the bar 50, such as retaining rings, cotter pins, plunger style quick release pins, or other similar detachable means of attachment. The lateral stops 53 may be made from aluminum, steel, synthetic materials or any similar substances or combinations thereof. In one aspect of the invention, the lateral stops 53 are made of ¼ inch by 1 inch 6061 T6 aluminum bar stock approximately 7 inches long bent at a 90 degree angle. The lateral stops 53 can be secured to the bar 50 using screws, if the bar is threaded, bolts and nuts, or other detachable means of attachment, such as cotter and clevis pins or plunger-style quick release pins. The lateral stops 53 may also be welded to the bar 50, which will prevent removal of the lateral stops 53 from the bar 50. The pins 80 may be clevis pins with detachable retainers, including cotter pins or locking rings, or may be wire lock pins, such as those depicted in FIG. 2, or may be a bolt and a nut, or any combination of these or similar devices.

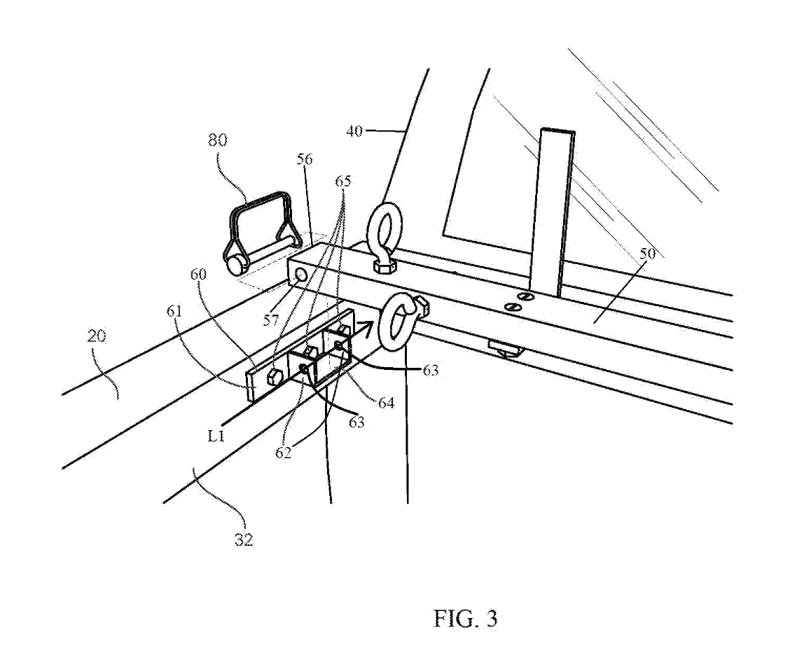

Turning to FIG. 3, the bar 50 is connected to the first installation bracket 60 by using a pin 80. The pin 80 connects the bar 50 to the first installation bracket 60 by passing through pair of collinear first pin apertures 63, located on the first retaining flange 62 of the first installation bracket 60, and through the first pin hole 57, located near the first end 56 of the bar 50. Similarly, the bar 50 may be disconnected from the second installation bracket 70 by removing the pin 80. When this occurs, the first end 56 will rest on the first horizontal member 64 of the first installation bracket. Further, in this embodiment, the presence of the first horizontal member 64 adds strength to the retaining flange 62 of the first installation bracket 60.

FIG. 3 further shows the first installation bracket 60 attached to the bed 20 of a pickup truck 40 using fasteners 75 to connect the first mounting flange 61 to the driver's side inner flange 31. These fasteners may be screws, bolts, rivets or other similar methods of mechanical attachment. Because an installer can access the backside of the passenger's side inner flange 32, retainers, such as nuts, may be used in the installation. Further, those of ordinary skill in the art will recognize that a shim, such as a peelable aluminum shim, may be placed between the first installation bracket 60 and the passenger's side inner flange 31 to help align the pair of collinear first pin apertures 63 with the first pin hole 57 if the bar 50 is slightly too short.

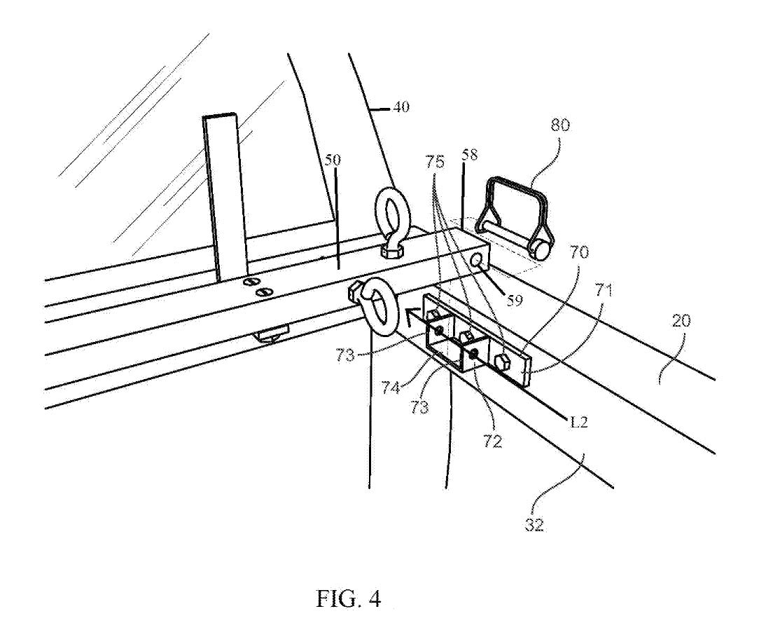

Turning to FIG. 4, the bar 50 is connected to the second installation bracket 70 by using a pin 80. The pin 80 connects the bar 50 to the second installation bracket 70 by passing through pair of collinear second pin apertures 73, located on the second retaining flange 72 of the second installation bracket 70, and through the second pin hole 59, located near the second end 58 of the bar 50. Similarly, the bar 50 may be disconnected from the second installation bracket 70 by removing the pin 80. When this occurs, the second end 58 will rest on the second horizontal member 74 of the second installation bracket 70. Further, in this embodiment, the presence of the second horizontal member 74 adds strength to the retaining flange 72 of the first installation bracket 70.

FIG. 4 further shows the second installation bracket 70 attached to the bed 20 of a pickup truck 40 using fasteners 75 to connect the second mounting flange 71 to the passenger's side inner flange 32. These fasteners may be screws, bolts, rivets or other similar methods of mechanical attachment. Because an installer can access the backside of the passenger's side inner flange 32, retainers, such as locking nuts, may be used in the installation. Further, those of ordinary skill in the art will recognize that a shim, such as a peelable aluminum shim, may be placed between the second installation bracket 70 and the passenger's side inner flange 32 to help align the pair of collinear second pin apertures 73 with the second pin hole 59 if the bar 50 is slightly too short.

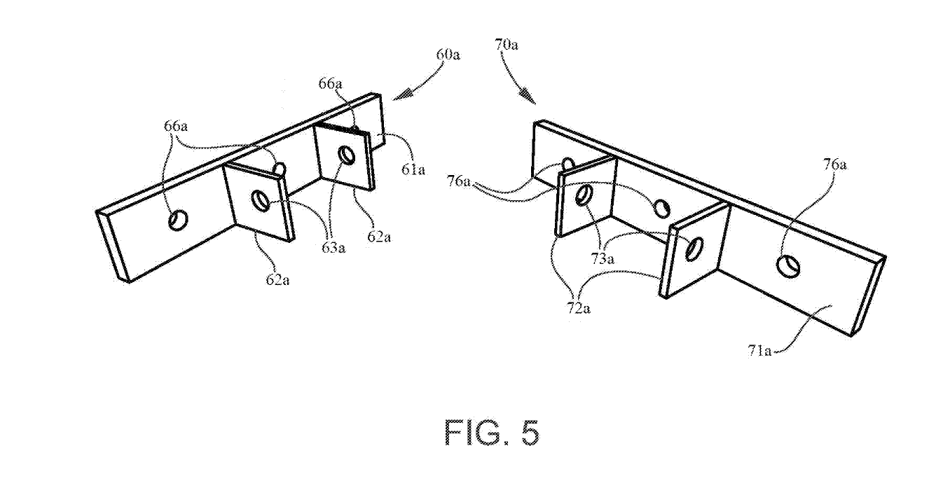

FIG. 5 shows alternative embodiments of the first installation bracket 60a and the second installation bracket 70a. Here, the first installation bracket 60a has a first retaining flange 62a through which the pair of collinear first pin apertures 63a are located. The first installation bracket 60a has a first mounting flange 61a with mounting holes 66a through which the fasters 75 depicted in FIG. 3 may be placed to attach the first installation bracket 60a to the driver's side inner flange 31. Similarly, the second installation bracket 70a has a second retaining flange 72a through which the pair of collinear second pin apertures 73a are located. The second installation bracket 70a has a second mounting flange 71a with mounting holes 76a through which the fasteners 75 depicted in FIG. 4 may be placed to attach the second installation bracket 70a to the passenger's side inner flange 32.

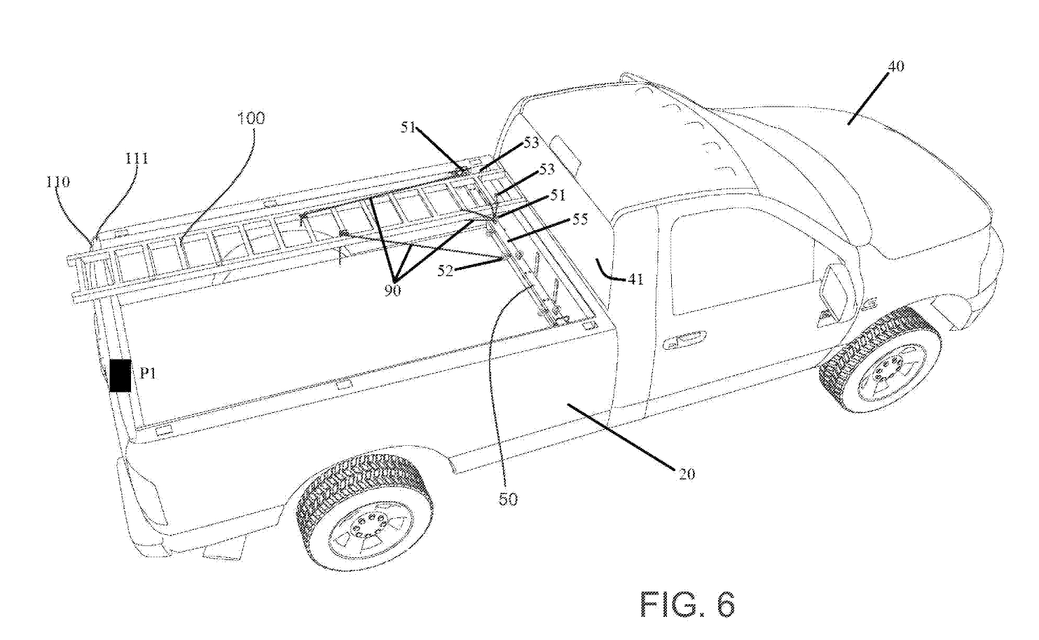

Turning to FIG. 6, cargo, such as a ladder 100, may be secured in the bed 20 of a pickup truck 40 using a securing attachment device 90 tied to the ladder 100 and to the horizontal tie downs 51 and vertical tie downs 52. The ladder 100 may rest on the upper surface 55 of the bar 50 and on the tailgate upper surface 111 of the tailgate 110 of a pickup truck 40. Further, the ladder 100 may also rest against the lateral stops 53, which will prevent the ladder from moving forward and striking the rear window 41 of the pickup truck 40 if the pickup truck 40 decelerates, such as when a pickup truck suddenly slams on the brakes while in motion. The securing attachment device 90 can be rope, a cargo strap, line, wire, bungee cord or the like.

As generally understood by reference to FIGS. 3, 4 and 6, the position of the bar 50 in the bed 20 of a pickup truck 40 may be varied by changing the placement of the first installation bracket 60 along the driver's side inner flange 31 and changing the placement of the second installation bracket 70 along the passenger's side inner flange 32. For instance, the upper surface 55 of the bar 50 may reside in a plane that is parallel to the plane P1 created by the tailgate upper surface ill of the tailgate 110 by positioning the first installation bracket 60 on the driver's side inner flange 31 and the second installation bracket 70 on the passenger's side inner flange 32 so that a line L1 through the center of the collinear first pin apertures 63 is coplanar with a line L2 through the center of the collinear second pin apertures 73 and parallel to a plane P1 occupied by the tailgate upper surface 111. With this in mind, the position of the first installation bracket 60 on the driver's side inner flange 31 and second installation bracket 70 on the passenger's side inner flange 32 may be adjusted until a line L1 through the center of the pair of first collinear pin apertures 63 is coplanar with a line L2 through the center of the pair of collinear second pin apertures 73, parallel to a plane P1 occupied by the tailgate upper surface 111, and is located an equal distance below the upper surface 55 of the rod 50 and the tailgate upper surface 111, which will result in the upper surface 55 being coplanar with the tailgate upper surface 111. In this installation, cargo, such as a ladder 100, that rests on the upper surface 55 and the tailgate upper surface 111, rests in a horizontal position when a pickup truck 40 is in a horizontal position.

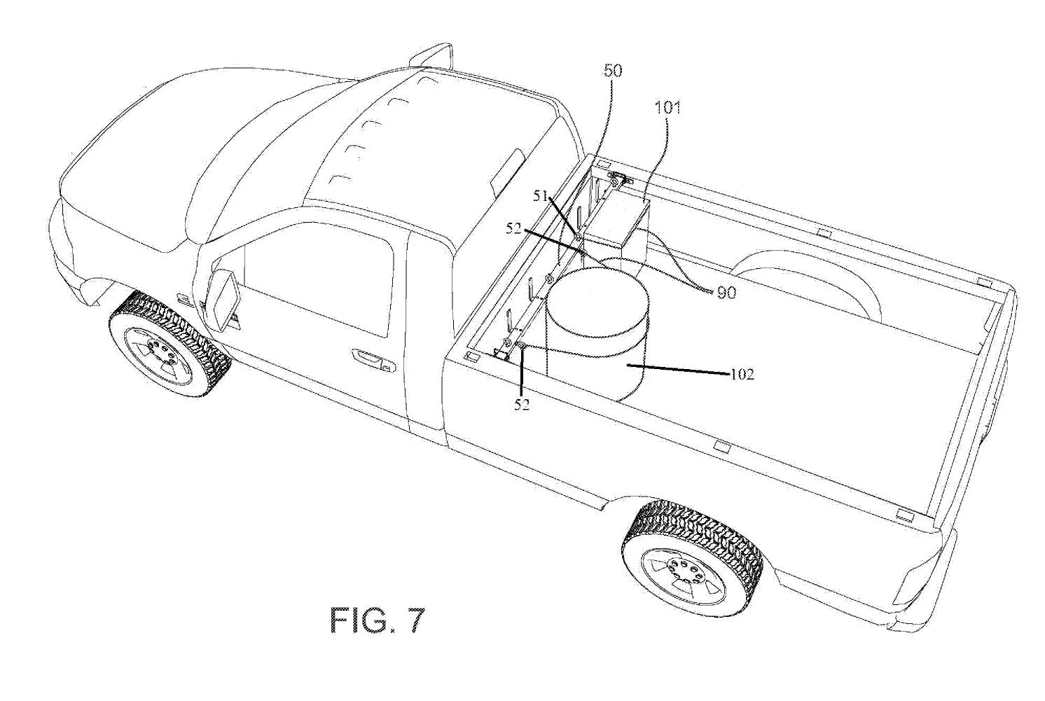

Turning to FIG. 7, other types of cargo, such as a box 101 or drum 102, may be secured in the bed 20 of a pickup truck 40 using a securing attachment device 90. The box 101 may rest on the cargo surface 55 of the bar 50 when a securing attachment device 90 secures the box 101 to the horizontal tie downs 52. Further, round cargo, such as a drum 102, may be secured between horizontal tie downs 52 using securing attachment device 90, which will restrict side-to-side movement of the round cargo.

While the preferred embodiments of the invention have been shown and described, those skilled in the art will recognize that other changes and modifications may be made to the foregoing embodiments without departing from the scope and spirit of the invention. For example, specific bar portion sizes and dimensions and specific shapes of various elements of the illustrated embodiments may be altered to suit particular applications. It is intended to claim all such changes and modifications as fall within the scope of the appended claims and their equivalents. Moreover, references herein to “top,” “lower,” bottom,” “upward,” “downward,” “upright,” and “side” structures, elements and geometries and the like are intended solely for purposes of providing an enabling disclosure and in no way suggest limitations regarding the operative orientation of the exemplary embodiments or any combinations thereof.

That which is claimed is:

1. A removable pickup truck tie down bar assembly for securing cargo in the bed of a pickup truck comprising:
a bar portion having a first end and a second end, the first end having a first pin hole and the second end having second pin hole and disposed opposite the first end;
a first installation bracket having a first mounting flange and a first retaining flange, the first retaining flange defining therethrough a pair of collinear first pin apertures, the first mounting flange attachable to a driver's side inner flange;
a second installation bracket having a second mounting flange and a second retaining flange, the second retaining flange defining therethough a pair of collinear second pin apertures, the second mounting flange attachable to a passenger's side inner flange opposite the first mounting flange;
a first end pin positioned through the first pin hole of the bar portion and the pair of collinear first pin apertures to connect the first end of the bar portion to the first installation bracket, the first end pin being removable from the first pin hole and the pair of first pin apertures to disconnect the bar portion from the first installation bracket; and
a second end pin positioned through the second pin hole and the pair of second pin apertures to connect the bar portion to the second installation bracket, the second-end pin being removable from the second pin hole and pair of collinear second pin apertures to disconnect the bar portion from the first installation bracket.

2. The removable pickup truck tie down bar assembly of claim 1 wherein the rod potion further comprises a horizontal tie down.

3. The removable pickup truck tie down bar assembly of claim 2 wherein the horizontal tie down is detachable from the rod portion.

4. The removable pickup truck tie down bar assembly of claim 1 wherein the rod portion further comprises a vertical tie down.

5. The removable pickup truck tie down bar assembly of claim 4 wherein the vertical tie down is detachable from the rod portion.

6. The removable pickup truck tie down bar assembly of claim 1 wherein the rod portion further comprises a lateral stop.

7. The removable pickup truck tie down bar assembly of claim 6 wherein the lateral stop is detachable from the rod portion.

8. The removable pickup truck tie down bar assembly of claim 1 wherein the rod portion further comprises a flat upper surface.

9. The removable pickup truck tie down bar assembly of claim 1 wherein the rod portion has a generally rectangular cross section.

10. The removable pickup truck tie down bar assembly of claim 1 further comprising:
a first horizontal member located on the first retaining flange of the first installation bracket; and
a second horizontal member located on the second retaining flange of the second installation.

11. The removable pickup truck tie down bar assembly of claim 1 wherein the first installation bracket further comprises mounting holes disposed on the first mounting flange.

12. The removable pickup truck tie down bar assembly of claim 1 wherein the second installation bracket further comprises mounting holes disposed on the second mounting flange.

13. A method for installing a removable pickup truck tie down bar in the bed of a pickup truck comprising:
providing a bar portion having a first end and a second end, the first end having a first pin hole and the second end having second pin hole and disposed opposite the first end;
providing a first installation bracket having a first mounting flange and a first retaining flange, the first retaining flange defining therethrough a pair of collinear first pin apertures;
securing the first mounting flange of the first installation bracket to a driver's side inner flange using securing means;
providing a second installation bracket having a second mounting flange and a second retaining flange, the second retaining flange defining therethough a pair of collinear second pin apertures;
securing the second mounting flange of the second installation bracket to a passenger's side inner flange opposite the first mounting flange of the first installation bracket using securing means;
aligning the first pin hole of the bar portion with the pair of collinear first pin apertures from the first installation bracket;
positioning a first end pin through the first pin hole of the bar portion and the pair of collinear first pin apertures to connect the first end of the bar portion to the first installation bracket;
aligning the second pin hole of the bar potion with the pair of collinear second pin apertures from the second installation bracket;
positioning a second end pin through the second pin hole of the bar portion and the pair of collinear second pin apertures of the second installation bracket to connect the bar portion to the second installation bracket.

14. The method for installing a removable pickup truck tie down bar in the bed of a pickup truck of claim 13 wherein the rod portion further comprises a horizontal tie down.

15. The method for installing a removable pickup truck tie down bar in the bed of a pickup truck of claim 13 wherein the rod portion further comprises a vertical tie down.

16. The method for installing a removable pickup truck tie down bar in the bed of a pickup truck of claim 13 wherein the rod portion further comprises a lateral stop.

17. The method for installing a removable pickup truck tie down bar in the bed of a pickup truck of claim 13 wherein the rod portion further comprises a flat upper surface.

18. The method for installing a removable pickup truck tie down bar in the bed of a pickup truck of claim 17 wherein the flat upper surface of the rod portion is generally coplanar with a tailgate upper surface.

19. The method for installing a removable pickup truck tie down bar in the bed of a pickup truck of claim 17 wherein the flat upper surface of the rod portion is generally parallel to a tailgate upper surface.

20. The method for installing a removable pickup truck tie down bar in the bed of a pickup truck of claim 13 further comprising:
a first horizontal member located on the first retaining flange of the first installation bracket;
a second horizontal member located on the second retaining flange of the second installation bracket; and
placing the first end of the bar portion on the first horizontal member and the second end of the bar portion on the second horizontal member before the first pin hole of the bar portion is aligned with the pair of collinear first pin apertures from the first installation bracket and before the second pin hole of the bar potion is aligned with the pair of collinear second pin apertures from the second installation bracket.

21. A removable pickup truck tie down bar assembly for securing items in the bed of a pickup truck comprising:
a bar portion of a generally rectangular cross section having a horizontal tie down, a vertical tie down, a horizontal stop, a first end and a second end disposed opposite the first end; a first pin hole disposed proximate the first end of the bar portion;
a second pin hole disposed proximate the second end;
a first installation bracket having a first mounting flange and a first retaining flange, the first mounting flange attachable to a driver's side inner flange, the first retaining flange having a first horizontal member and a a pair of collinear first pin apertures;
a second installation bracket having a second mounting flange and a second retaining flange, the second mounting flange attachable to a passenger's side inner flange, the second retaining flange having a second horizontal member and a pair of collinear second pin apertures;
a first-end pin positioned in the first pin hole of the bar portion and the pair of collinear first pin apertures to connect the first end of the bar portion to the first installation bracket, the first-end pin being removable from the first pin hole and the pair of collinear first pin apertures to disconnect the bar portion from the first installation bracket;
a second-end pin positioned in the second pin hole and the pair of collinear second pin apertures to connect the bar portion to the second installation bracket, the second-end pin being removable from the second pin hole and the pair of collinear second pin apertures to disconnect the bar portion from the first installation bracket;
Whereby, when the bar portion is disconnected from the first installation bracket and the second installation bracket, the first end rests in the first horizontal member of the first installation bracket and the second end rests in the second horizontal member of the second installation bracket.

22. The removable pickup truck tie down bar of claim 21 further comprising four vertical tie-downs on the bar portion.

23. The removable pickup truck tie down bar of claim 21 further comprising four horizontal tie-downs on the bar portion.

24. The removable pickup truck tie down bar of claim 21 further comprising four horizontal stops on the bar portion.
